(19) United States
(12) Patent Application Publication
(10) Pub. No.: US 2006/0151265 A1
(43) Pub. Date: Jul. 13, 2006

(54) Nagative brake device, construction machine, and method of activating negative

(75) Inventors: Kouhei Honjou, Abiko-shi (JP); Kenichirou Date, Tsuchiura-shi (JP); Hiroyuki Hoshino, Tsuchiura-shi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Sumitomo Heavy Industries Construction Crane Co., Ltd., Taito-ku (JP)

(21) Appl. No.: 10/544,633

(22) PCT Filed: Feb. 5, 2004
(86) PCT No.: PCT/JP04/01171

§ 371 Date: Aug. 5, 2005

(30) Foreign Application Priority Data
Feb. 5, 2003 (JP) 2003-027975

(51) Int. Cl. F16D 55/36

(52) U.S. Cl. 188/170; 188/71.5

(57) ABSTRACT

The present invention includes a hydraulic source (23), a pressure reducing valve (22) that reduces hydraulic pressure from the hydraulic source (23) so as secondary pressure P to become large in accordance with increase in an extent to which a pusher (25) is pressed in, a negative brake mechanism (10) that releases braking by secondary pressure P from the pressure-reducing valve (22) and causes braking to operate in response to cutting of secondary pressure (P), a brake pedal (24) provided so as to pull out the pusher (25) according to a depression operation, and a spring member (27) that pushes in the pusher (25) so as to release braking performed by the negative brake mechanism (10) when the brake pedal (24) is not operated.

### TECHNICAL FIELD

The present invention relates to negative brake apparatus for releasing a brake using hydraulic pressure and operating a brake by interrupting the hydraulic pressure, construction machinery, and a negative brake method.

### BACKGROUND ART

Cranes equipped with this type of negative brake apparatus are known in the related art (for example, Japanese Laid Open Patent Publication No. H9-216793). According to this publication, oil chambers are provided on both sides of a brake piston, with negative braking being released upon supplying pressurized oil to one of the oil chambers, and a hydraulic brake being operated upon supplying pressurized oil to the other oil chamber according to operation of a brake pedal. When the supply of oil to an oil chamber for brake release use is cut, negative braking acts due to the urging force of a spring.

With the device in the aforementioned publication, because oil chambers are provided on both sides of the brake piston and oil flows to each oil chamber are to be controlled, the structure of the brake apparatus is complex. Further, when the pressurized oil supply for braking operation use is cut due to whatever reason (abnormality) during the braking operation, the brake enters a non-operating state (freestate)

### DISCLOSURE OF THE INVENTION

A negative brake apparatus according to the present invention includes a hydraulic source; a negative brake mechanism that releases braking in response to supply of pressurized oil and causes braking to operate by interruption of pressurized oil from the hydraulic source; a control valve that controls pressure of pressurized oil supplied from the hydraulic source to the negative brake mechanism; and a brake operation device that operates the control valve.

Furthermore, A negative brake apparatus according to the present invention includes a hydraulic source; a negative brake mechanism that releases braking in response to supply of pressurized oil supplied from the hydraulic source and increases braking force according to a reduction in pressure of supplied pressurized oil; a control valve that controls pressure of pressurized oil supplied from the hydraulic source to the negative brake mechanism; and a brake operation device that operates the control valve.

It is preferable that the control valve is controlled so as to reduce pressure of the pressurized oil supplied from the hydraulic source to the negative brake mechanism when the brake operation device is operated in a brake operation direction.

It is preferable for the negative brake mechanism described above to be provided at a winch, and that the brake operation device is a brake pedal for braking the winch.

A negative brake apparatus according to the present invention includes a hydraulic source; a pressure reducing valve that reduces hydraulic pressure from the hydraulic source so as secondary pressure to become large in accordance with increase in an extent to which a pusher is pressed in; a negative brake mechanism that releases braking by secondary pressure from the pressure-reducing valve and causes braking to operate in response to cutting of secondary pressure; a brake pedal provided so as to pull out the pusher according to a depression operation; and a spring member that pushes in the pusher so as to release braking performed by the negative brake mechanism when the brake pedal is not operated.

In this manner, by means of a general purpose pressure-reducing valve, the safer negative brake mechanism can be constructed in a straightforward manner.

The pressure-reducing valve may include a return spring that returns the pusher to a pulled-out position and the spring member may push in the pusher against urging force of the return spring.

It is preferable to further provide an adjustment means for adjusting a relationship between extent of operation of the brake pedal and secondary pressure. The adjustment means may include a varying mechanism that changes an extent to which the pusher is pressed in when the brake pedal is not operated.

Great advantages can be obtained by installing the negative brake apparatus to a construction machine. In particular, it is preferable for the negative brake apparatus to be provided at the construction machine which includes a winch drum; and a free-fall switch that instructs free falling of the winch drum, and to brake rotation of the winch drum at a time of free fall.

A braking method according to the present invention employs a pressure-reducing valve set to increase secondary pressure outputted in accordance with pushing in of a pusher, and is used for causing a brake apparatus to operate based on the secondary pressure. According to the method, secondary pressure outputted from the pressure-reducing valve is outputted to the brake apparatus as brake releasing pressure with the pusher of the pressure-reducing valve in a pressed in state when a brake operation member is in a non-operating state; and secondary pressure outputted after being reduced by pulling out of the pusher of the pressure-reducing valve is outputted to the brake apparatus with the brake operation member in an operating state.

### BRIEF DESCRIPTION OF THE DRAWINGS

FIG. 1 is a hydraulic circuit diagram for a winch having a negative brake apparatus of an embodiment of the present invention;

FIG. 2 is a schematic view of the essential parts of a pressure-reducing valve of an embodiment of the present invention;

FIG. 3(a) and FIG. 3(b) are respective characteristic views for the reducing valve of FIG. 2;

FIG. 4(a) is a view showing the action at the time of non-operation of a brake pedal, and FIG. 4(b) is a view showing the action at the time of depression of the brake pedal;

FIG. 5 is a view showing the operation at the time of link drop-out;

FIG. 6 is a side-view of a crane to which the present invention is applied;

FIG. 7 is a schematic view of another pressure-reducing valve;

FIG. 8 is a view showing a modified example of the negative brake apparatus of an embodiment of the present invention;

FIG. 9 is a view showing a characteristic for brake force when the brake apparatus of FIG. 8 are not applied;

FIG. 10 is a view showing a characteristic for brake force when the brake apparatus of FIG. 8 are applied;

FIG. 11 is a view showing a characteristic of the pressure-reducing valve when the brake apparatus of FIG. 8 are applied.

### BEST MODE FOR CARRYING OUT THE INVENTION

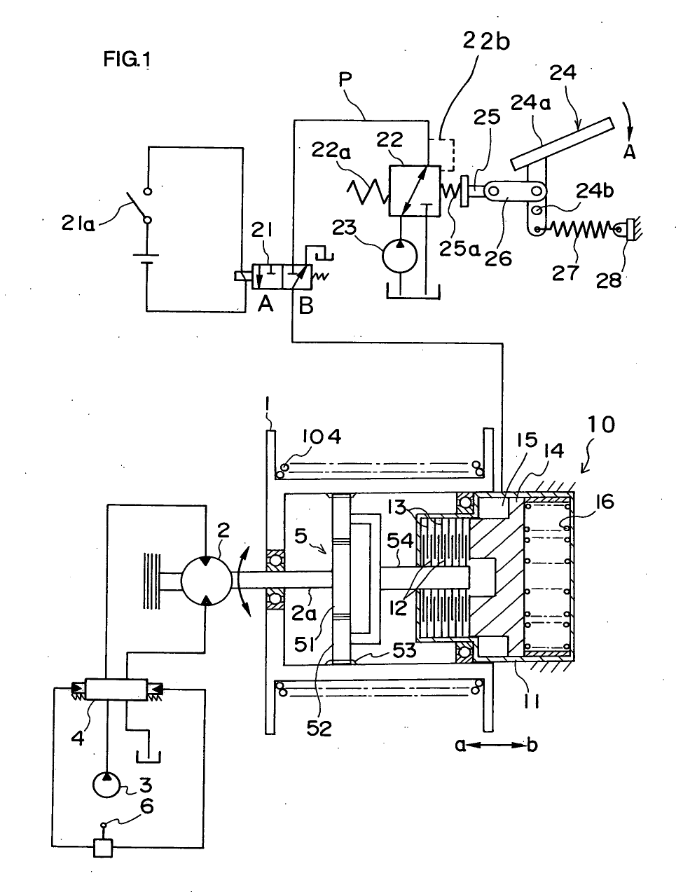

The following is a description with reference to FIG. 1 to FIG. 11 of an embodiment of a negative brake apparatus of the present invention.

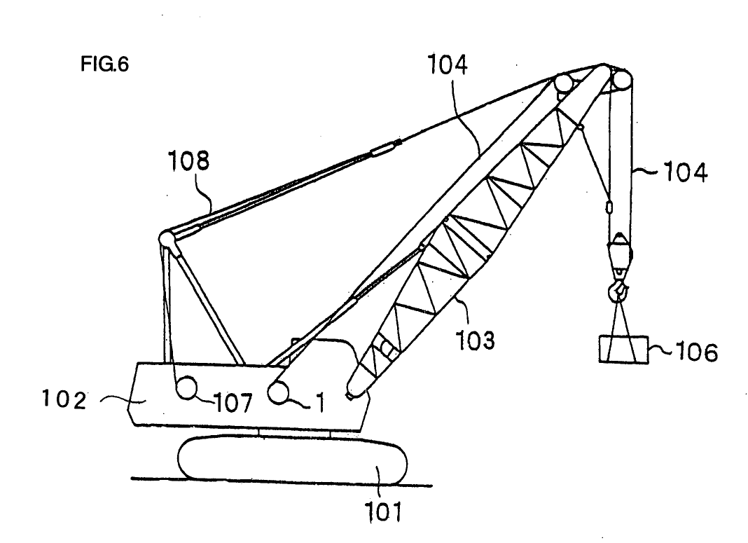

FIG. 1 is a hydraulic circuit diagram of a winch having the negative brake apparatus of an embodiment of the present invention, and FIG. 6 is a side view of a crane on which the brake apparatus is mounted. As shown in FIG. 6, the crane includes a travelling body 101, a revolving superstructure 102 capable of turning mounted on the travelling body 101, and a boom 103 capable of hoisting up/down supported at the revolving superstructure 102. A winch drum 1 is mounted at the revolving superstructure 102 so that a lifting load (bucket etc.) 106 can be raised and lowered as a result of a wire rope 104 being wound or unwound by driving the winch drum 1. Further, a hoist drum 107 is mounted at the revolving superstructure 102, and a hoist rope 108 is wound up and wound down as a result of driving by the derricking drum 107 so that the boom is hoisted up/down.

As shown in FIG. 1, a hoisting winch includes a winch drum 1, a hydraulic motor 2 for driving the winch drum 1 to wind up/down, a variable displacement hydraulic pump 3 for supplying pressurized oil for driving to the hydraulic motor 2, a direction control valve 4 operated by pilot pressure according to operation of an operation lever 6, for controlling flow of pressurized oil from the variable displacement hydraulic pump 3 to the hydraulic motor 2, a planetary gear speed reducing mechanism 5 built into the winch drum 1 for transmitting drive force of the hydraulic motor 2 to the winch drum 1, and a wet multi-disc type brake apparatus 10 for braking rotation of the winch drum 1.

An output shaft 2a of the hydraulic motor 2 is coupled to a sun gear 51 of the planetary gear speed reducing mechanism 5. A planetary gear 52 meshes with the sun gear 51, and a ring gear 53 provided at an inner peripheral surface of the winch drum 1 meshes with the planetary gear 52. The planetary gear 52 is supported by a carrier shaft 54.

A brake case 11 is arranged at the side of the planetary gear speed reducing mechanism 5. The carrier shaft 54 passes through a side wall of the brake case 11, and a plurality of inner discs 12 are spline-fit at an end of the carrier shaft 54 in such a manner as to enable movement in an axial direction. A plurality of outer discs 13 engage in a manner enabling movement in an axial direction as a result of spline-fitting at the inner peripheral surface of the brake case 11. The outer discs 13 and the inner discs 12 are arranged alternately in axial direction. A brake piston 14 is arranged within the brake case 11 in a manner enabling sliding in an axial direction at a side of the discs 12 and 13. An oil chamber 15 is formed at one side (the side of disc 12 and 13) in an axial direction of the brake piston 14, with a spring 16 being interposed at an opposite side in an axial direction.

The spring 16 always exerts urging force on the brake piston 14, the brake piston 14 moves in the direction “a” shown in the drawing due to the urging force of the spring 16, and the discs 12 and 13 are pressed together due to pressure. Rotation of the inner disc 12 is thus prevented and the brake operates. On the other hand, when hydraulic pressure acts at the oil chamber 15, the brake piston 14 resists the urging force of the spring 16 so as to move in direction “b” shown in the drawing, and the pressing force acting on the discs 12 and 13 is released. Rotation of the inner disc 12 is then permitted and the brake is released. The discs 12 and 13, piston 14, oil chamber 15 and spring 16 form a so-called negative brake mechanism that releases the brake using hydraulic pressure and performs a brake operation by interrupting the hydraulic pressure. Cooling oil flows within the brake case 11 (omitted from the drawings) so as to cool the discs 12 and 13.

The oil chamber 15 is connected to a hydraulic pump 23 via a solenoid controlled directional control valve 21 and a pressure-reducing valve 22. The solenoid controlled directional control valve 21 is switched over by the operation of a free-fall switch 21a and permits or prohibits the flow of pressurized oil to the oil chamber 15. The pressure-reducing valve 22 is a variable pressure-reducing valve and the extent of the reduction can be changed according to the extent of depression of a brake pedal 24. Namely, the pressure-reducing valve 22 controls reduction of hydraulic pressure using the balance of a regulation spring 22a and secondary pressure P supplied by a secondary pressure supply pipe 22b. The spring force of the regulation spring 22a is changed according to the extent of drive of a pusher 25, and the pusher is driven according to the extent of depression of the brake pedal 24 so as to adjust the spring force of the regulation spring 22a.

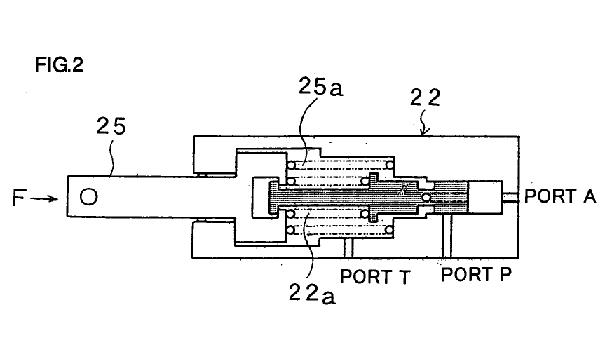

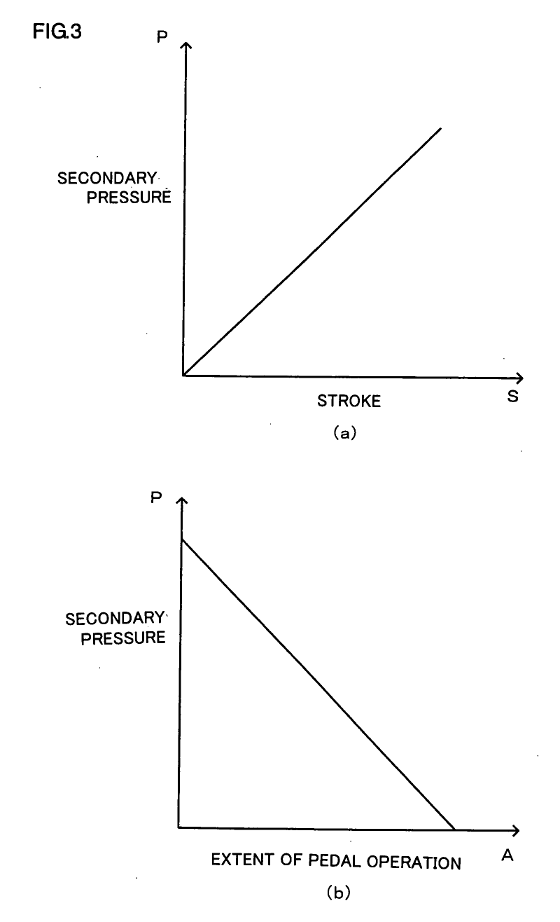

A more detailed description is given of the configuration of the pressure reducing valve 22. FIG. 2 is a schematic view showing the relationship of a return spring 25a and the pusher 25. As shown in the drawing, the pusher 25 is pulled out to maximum in a neutral state by the spring force of the return spring 25a. When an external force F acts in resistance to the spring force of the return spring 25a, the pusher 25 is pushed in by the external force F. The relationship between the extent of depression (stroke S) of the pusher 25 from the neutral position and the secondary pressure P of the pressure reducing valve 22 is as shown in FIG. 3(a), with the secondary pressure P being proportionally increased in accordance with increase of the stroke S.

The pressure reducing valve 22 constructed in this manner can therefore be constructed in a straightforward manner, usefulness is increased, and availability is also good. If the negative braking operation is to be performed in response to depression of the brake pedal 24 using the pressure-reducing valve 22, it is necessary for the secondary pressure P to be reduced in accordance with increase in the extent of operation of the pedal A as shown in FIG. 3(b). In order to implement this, in this embodiment, the pusher 25 of the pressure-reducing valve 22 is connected to the brake pedal 24 in the following way.

As shown in FIG. 1, one end of a link 26 is coupled between a depression section 24a of the brake pedal 24 and a turning shaft 24b and another end of the link 26 is coupled to the pusher 25. An end of a return spring 27 is coupled to a lower end of the brake pedal 24 below the turning shaft 24b and the other end of the return spring 27 is coupled to a bracket 28 provided at a body frame.

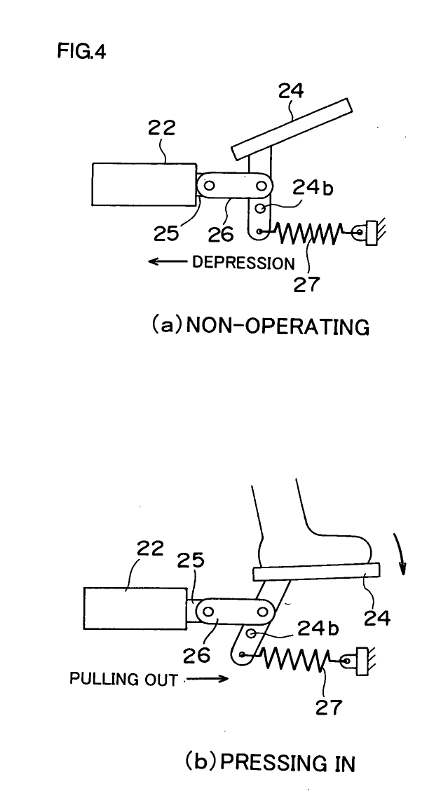

The return spring 27 is a tension spring, and spring force (extension force) of the return spring 27 is applied as compression force to the return spring 25a via brake pedal 24, the link 26 and the pusher 25. Spring force of the return spring 27 occurring in the neutral state is set to be larger than the spring force of the return spring 25a so that the return spring 25a is compressed when the brake pedal 24 is not in operation, with the pusher 25 being pushed in to a maximum extent as shown in FIG. 4(a). As a result, the secondary pressure P becomes a maximum and the brake is released. When the brake pedal 24 is then depressed, the pusher 25 is pulled out so as to resist the spring force of the return spring 27 as shown in FIG. 4(b). As a result, the secondary pressure P is reduced, and the brake operates.

Next, a specific description is given of the operation of this embodiment.

(1) Free Fall Switch Off

When the free-fall switch 21a is off, as shown in FIG. 1, the solenoid controlled directional control valve 21 is switched over to position (B), and the oil chamber 15 communicates with a reservoir. The brake piston 14 is then pushed in direction “a” of FIG. 1 by the urging force of the spring 16, and the inner discs 12 and outer discs 13 are pressed against each other through pressure. Frictional force then acts on the inner disc 12 due to this pressure, and rotation of the discs 12 is prevented (brake operation).

When the brake apparatus 10 operates in this manner, rotation of the carrier shaft 54 is prevented, and rotation of the hydraulic motor 2 can be transmitted to the winch drum 1 via the sun gear 51, planetary gear 52, and ring gear 53. When the operation lever 6 is operated to perform hoisting or lowering so that direction switching valve 4 is switched over, pressurized oil is supplied from the hydraulic pressure pump 3 to the hydraulic motor 2, and the hydraulic motor 2 is rotated in a direction of winding up or down. As a result, the winch drum 1 is driven to wind up/down so as to carry out operations such as hoisting of the lifting load. When the operation lever 6 is operated back to a neutral position, supply of pressurized oil to the hydraulic motor 2 is prevented and rotation of the hydraulic motor 2 is stopped.

(2) Free Fall Switch On

When the free-fall switch 21a is turned on, the solenoid controlled directional control valve 21 is switched to position (A), and the pressure-reducing valve 22 and oil chamber 15 communicate with each other via the solenoid controlled directional control valve 21. When the operation lever 6 is put into a neutral position so as to stop rotation of the hydraulic motor 2 and the brake pedal 24 is not operated with the lifting load held airborne, the secondary pressure P after passage through the pressure-reducing Valve 22 becomes a maximum. As a result, hydraulic pressure acting on the brake piston 14 overcomes the urging force of the spring 16, and the brake piston 14 presses in direction “b” of FIG. 1. The pressing force acting on the discs 12 and 13 is therefore released, and the inner discs 12 are capable of rotating (brake release).

When the brake apparatus 10 is released, rotation of the carrier shaft 54 is permitted, and the winch drum 1 rotates freely due to the load of the lifting load so that the lifting load is put into free-fall. When the brake pedal 24 is depressed in this state, the secondary pressure P is reduced in accordance with increase of the extent of the pedal operation, and the hydraulic pressure acting on the brake piston 14 becomes smaller than the urging force of the spring 16. As a result, the brake piston 14 is pushed in direction “a” according to the extent of operation of the brake pedal 24, the discs 12 and 13 are pressed together, and rotation of the winch drum 1 is stopped (brake operation).

(3) Abnormal Situations

For example, when oil leaks occur in the hydraulic circuit connecting the hydraulic pump 23 and the oil chamber 15 so that the supply of pressurized oil to the oil chamber 15 is cut, the brake piston 14 is pushed in direction “a” by the urging force of the spring 16 and the negative brake operates. It is therefore possible to prevent falling of the lifting load even in cases where oil leaks occur with the lifting load held airborne.

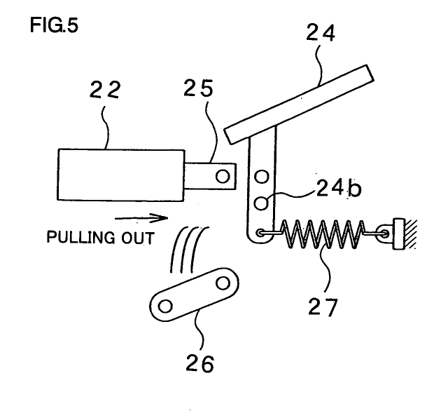

Further, when the link 26 drops out as shown in FIG. 5 so that coupling of the brake pedal 24 and pusher 25 is broken, spring force of the return spring 27 is not transmitted to the pusher 25, the pusher 25 is pulled out by the spring force of the return spring 25a and returns to the neutral position. The pusher 25 similarly returns to a neutral position when the return spring 27 or the brake pedal 24 drops out. As a result, the secondary pressure P becomes a minimum, and the negative brake operates so that countermeasures for stabilizing abnormal situations are achieved.

According to this embodiment, the return spring 27 is coupled to the brake pedal 24, the pusher 25 is pushed in by spring force of the return spring 27 when the brake pedal 24 is not operated, and there is resistance to the spring force of the return spring 27 in accordance with increase in the extent of depression of the brake pedal 24 so that the pusher 25 is pulled out. In this way, secondary pressure P is reduced in accordance with increase in the extent of operation of the brake pedal 24, and a configuration for the negative brake apparatus can be made simple. Namely, the spring 16 is provided at one side of the brake piston 14 and the oil chamber 15 is provided on the opposite side. Secondary pressure P therefore passes to the oil chamber 15 at the time of non-operation of the brake pedal 24 so as to release the negative brake, the secondary pressure P is blocked by depression of the brake pedal 24, making it possible for the brake to operate.

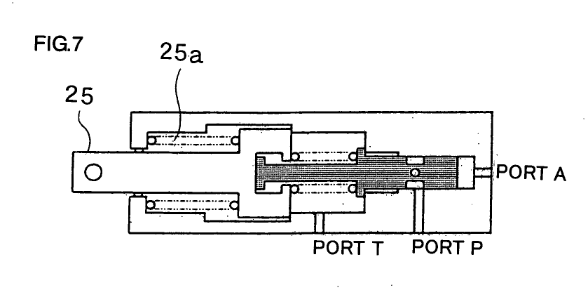

Further, a general purpose pressure-reducing valve 22 enabling the pusher 25 to be pulled out by the return spring 25a in a neutral state so as to make secondary pressure a minimum is employed so as to make it possible to cheaply construct the brake apparatus 10. Further, in the event that external force acting on the pusher 25 is released due to falling out of the link 26 etc., the pusher 25 is pulled out so that the secondary pressure P becomes a minimum and the negative brake therefore acts so that stability is improved. Contrary to this, if a so-called inverse proportional type pressure-reducing valve was employed by which the secondary pressure P is reduced in accordance with an increase in the stroke S of the pusher 25, the structure would become complex compared to the pressure-reducing valve 22 of this embodiment and also, the secondary pressure P would become a maximum at the time of the link 26 dropping out, which is not preferable from a safety point of view. Further, in the case of a type of pressure-reducing valve where the pusher 25 is pushed in by there turn spring 25a in the neutral state as shown, for example, in FIG. 7, the secondary pressure P becomes a maximum at the time of dropping out of the link 26 and stability is therefore not appropriate.

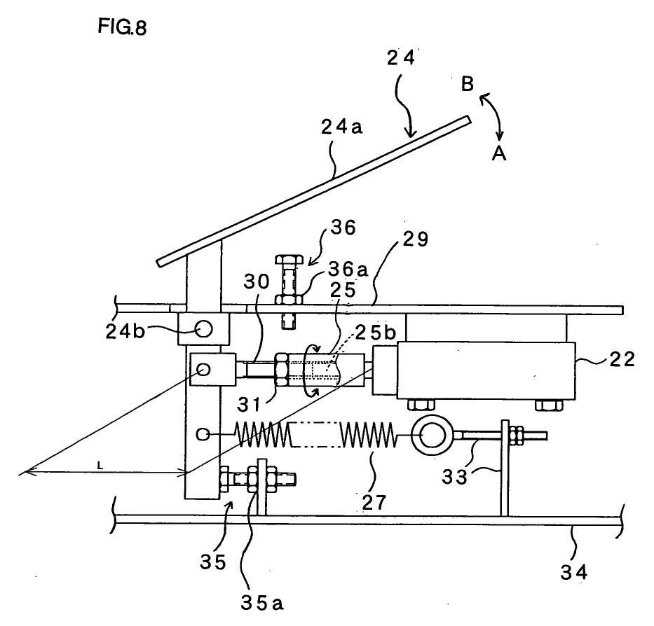

In the above, the return spring 27 is coupled to the lower end part of the brake pedal 24 as a spring member but may also be coupled to another location (for example, between the depression section 24a and the turning shaft 24b). In this case, the bracket 28 for spring coupling may be provided at the side of the pusher 25 in such a manner that the pusher 25 is pushed in when the brake pedal 24 is not in operation or alternatively, the return spring 27 may be a compression spring rather than the tension spring. Further, the pusher 25 and the pressure-reducing valve 22 are provided on the opposite side of the return spring 27 but may also be provided at the side of the return spring 27 (for example, refer to FIG. 8). In this case, the link 26 may be coupled to below the turning shaft 24b. The structure of the negative brake mechanism is by no means limited to that described above. The solenoid controlled directional control valve 21 is provided between the pressure-reducing valve 22 and the oil chamber 15 but the configuration of the hydraulic circuit is by no means limited in this respect.

### MODIFIED EXAMPLES

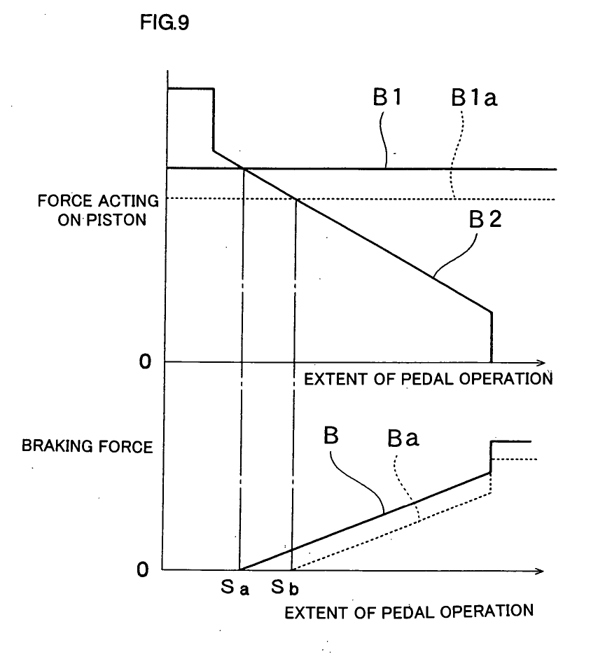

When the urging force of the spring 16 acting on the brake piston 14 is taken to be B1, the hydraulic pressure of the oil chamber 15 resisting this urging force is taken to be B2, and the brake force acting on the drum 1 is taken to be B, the relationship between B1, B2 and B and the extent of operation of the pedal is, for example, shown in FIG. 9. Namely, the urging force B1 is fixed regardless of the extent of operation of the pedal, while the hydraulic pressure B2 changes in accordance with the characteristic (the characteristic of FIG. 3(b)) of the pressure-reducing valve 22.

Here, when the initial length of the spring 16 is set offset from an appropriate value due to the parts manufacturing tolerance and assembly error, etc., the spring characteristic is shifted, for example, from the characteristic B1 (solid line) of FIG. 9 to the characteristic B1a (dotted line). As a result, the brake force characteristic shifts from B (solid line) to Ba (dotted line). As a result, because the point of commencement of use of the brake is shifted from Sa to Sb, the brake force with respect to a prescribed pedal operation amount becomes different and operability becomes poor. In order to avoid this, it is preferable, for example, to construct a negative brake apparatus equipped with a mechanism for adjusting brake force as described below.

FIG. 8 is a front view showing the essential parts of negative brake apparatus having a brake force adjustment mechanism. The brake pedal 24 is provided in a turnable manner having the turning shaft 24b below a floor plate 29 as a fulcrum. One end of the return spring 27 is coupled to the vicinity of the lower end of the brake pedal 24, and the other end is fixed to a bottom plate 34 via a bracket 33. The return spring 27 urges the brake pedal 24 in such a manner as to cause the brake pedal 24 to rotate in an anti-clockwise direction (direction B) taking the turning shaft 24b as a fulcrum.

The pressure-reducing valve 22 is arranged above the return spring 27 and the pressure-reducing valve 22 is fixed to the back side of the floor plate 29. The structure of the pressure-reducing valve 22 is the same as for that shown in FIG. 2, and the pusher 25 is fitted to one end of a spool of the pressure-reducing valve 22.

A female thread 25b is formed at one end of the pusher 25. One end of a bolt 30 is threaded into the female thread 25b and is fixed using a nut 31. The other end of the bolt 30 is coupled in a rotatable manner lower down from the turning shaft 24b of the brake pedal 24. As a result, when the brake pedal 24 is depressed, the brake pedal 24 is rotated in a clockwise direction (direction A) taking the turning shaft 24b as a fulcrum, and the pusher 25 is pulled out via the bolt 30 as a result of this rotation. As a result, the secondary pressure P is reduced, and the brake operates. On the other hand, when a foot is taken off the brake pedal 24, the brake pedal 24 rotates in an anti-clockwise direction (direction B) due to the urging force of the return spring 27 and the pusher 25 is pushed within the pressure-reducing valve 22. As a result, the secondary pressure P is increased and the brake is released.

A stopper 35 is provided at the bottom plate 34, the lower end of the brake pedal 24 comes into contact with this stopper 35 and the initial position of the brake pedal 24 is restricted. A stopper 36 is provided at the floor plate 29, the rear surface of the brake pedal 24 comes into contact with this stopper 36 and the maximum stroke of the brake pedal 24 is restricted. The stoppers 35 and 36 are fixed by nuts 35a and 36a and the positions of the stoppers 35 and 36 can be adjusted by loosening the nuts 35a and 36a.

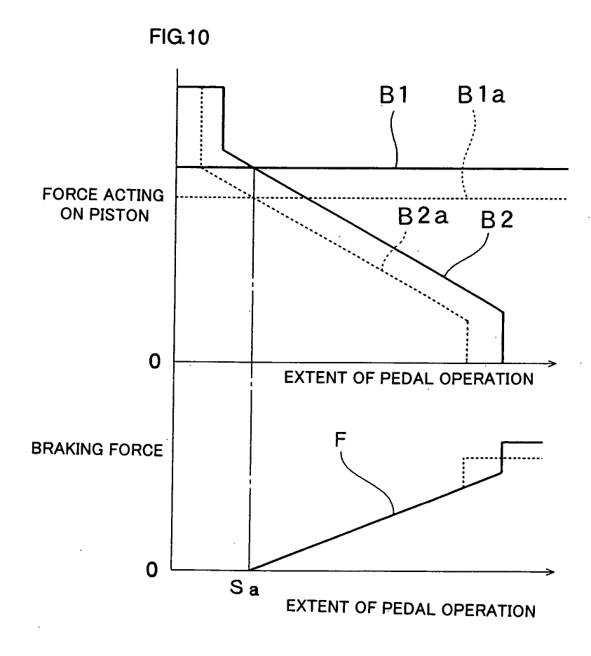

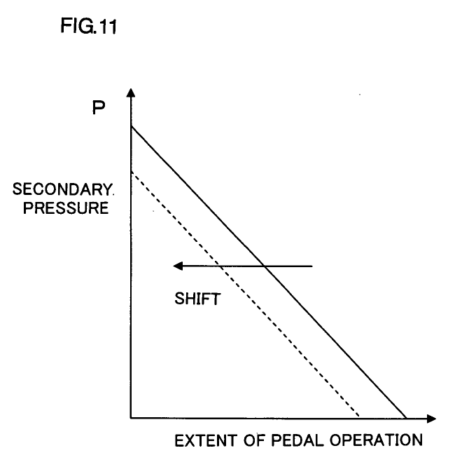

In order to adjust brake force, the nut 31 is loosened, the pusher 25 is made to rotate, and the extent of screwing in of the bolt 30 is changed. As a result, the length L from the pusher 25 to the brake pedal 24 is changed. For example, when the length L becomes long, the extent of pushing in of the pusher 25 is increased, and the extent of compression of the relief spring 22a occurring in a neutral state is increased, causing the characteristic of the pressure-reducing valve 22 to be shifted as shown by the dotted line in FIG. 11. As a result, as shown in FIG. 10, the hydraulic force acting on the brake piston 14 is shifted from B2 (solid line) to B2a (dotted line), and the urging force B1a and hydraulic pressure B2a become the same for an extent of pedal operation Sa. As a result, the brake force characteristic becomes the same as the characteristic F and superior operativity can be obtained. In this case, the spring 16 is required to have the urging force great enough to make the discs 12 and 13 press against each other. The spring constant of the spring 16 is therefore large, and adjustment of the brake force by adjusting the initial length of the spring 16 is difficult. However, in this embodiment, adjustment of brake force is straightforward because it is not necessary to adjust the initial length of the spring 16.

Adjustment of the brake force described above may be carried out, for example, at the time of assembly of the brake apparatus 10. Namely, the brake force with respect to the amount of operation of the pedal for the brake apparatus 10 is to be checked, and the extent of screwing in of the bolt 30 is adjusted in such a manner that the checked value becomes an appropriate value. Checking of the brake force may also be carried out periodically not only at the time of assembly. As a result, compatibility with cases where brake force characteristics change for some reason (for example, friction of discs 12 and 13) can be achieved in a straightforward manner.

In the embodiment described above, the brake apparatus and the clutch apparatus are provided in common using the planetary gear speed reducing mechanism 5 but the embodiment may also be similarly applied to a brake-dedicated apparatus that does not have the planetary gear speed reducing mechanism 5. In the above embodiment, the pressure-reducing valve 22 is set in-such a manner that the secondary pressure outputted in accordance with pressing in of the pusher 25 becomes large, the pusher 25 is put in a pushed-in state in a non-operating state (normal state), the pusher 25 having been pushed in is pulled out in an operation state, and the secondary pressure outputted from the pressure-reducing valve 22 is reduced in accordance with an increase in the extent of the operation but the configuration of the brake apparatus is not limited in this respect. It is also possible to utilize various control valves where pressure can be controlled in the negative brake apparatus such as inverse-proportional types of pressure-reducing valves and relief valves where secondary pressure P becomes large in accordance with increase in the extent of pressing of the pusher 25.

### INDUSTRIAL APPLICABILITY

The present invention can be applied to construction machines other than cranes.

This application is based on Japanese Patent Application No. 2003-27975 and the contents of that application are hereby incorporated by reference.

1-4. (canceled)

5. A negative brake apparatus comprising:
a hydraulic source;
a pressure reducing valve that reduces hydraulic pressure from the hydraulic source so as secondary pressure to become large in accordance with increase in an extent to which a pusher is pressed in;
a negative brake mechanism that releases braking by secondary pressure from the pressure-reducing valve and causes braking to operate in response to cutting of secondary pressure;
a brake pedal provided so as to pull out the pusher according to a depression operation; and
a spring member that pushes in the pusher so as to release braking performed by the negative brake mechanism when the brake pedal is not operated.

6. A negative brake apparatus according to claim 5, wherein:
the pressure-reducing valve comprises a return spring that returns the pusher to a pulled-out position and the spring member pushes in the pusher against urging force of the return spring.

7. A negative brake apparatus according to claim 5, further comprising:
an adjustment device that adjusts a relationship between extent of operation of the brake pedal and secondary pressure.

8. A negative brake apparatus according to claim 7, wherein:
the adjustment device comprises a varying mechanism that changes an extent to which the pusher is pressed in when the brake pedal is not operated.

9. A construction machine comprising a negative brake apparatus according to claim 5.

10. A construction machine according to claim 9 comprising:
a winch drum; and
a free-fall switch that instructs free falling of the winch drum, wherein:
the negative brake apparatus brakes rotation of the winch drum at a time of free fall.

11. A braking method employing a pressure-reducing valve set to increase secondary pressure outputted in accordance with pushing in of a pusher, for causing a brake apparatus to operate based on the secondary pressure, comprising the steps of:
outputting secondary pressure outputted from the pressure-reducing valve to the brake apparatus as brake releasing pressure with the pusher of the pressure-reducing valve in a pressed in state when a brake operation member is in a non-operating state; and
outputting secondary pressure outputted after being reduced by pulling out of the pusher of the pressure-reducing valve to the brake apparatus with the brake operation member in an operating state.
